(19) United States
(12) Patent Application Publication
(10) Pub. No.: US 2009/0277152 A1
(43) Pub. Date: Nov. 12, 2009

(54) Quasi-isobaric heat engine

(76) Inventor: Ronald Steven Sutherland, Show Low, AZ (US)

Correspondence Address: RONALD STEVEN SUTHERLAND, 321 S. 5th Place 85901, Show Low, AZ, 85901, US

(21) Appl. No.: 12/384,841

(22) Filed: Apr. 8, 2009

Related U.S. Application Data
(60) Provisional application No. 61/126,805, filed on May 7, 2008.

(51) Int. Cl. F02C 3/04

(52) U.S. Cl. 60/39.63

(57) ABSTRACT

One embodiment of a heat engine machine enabling a user to convert heat sources into mechanical work or compressed air. The heat engine requires solar radiation and air. The thermodynamic cycle is quasi-isobaric, and comprise positive displacement compressors 16A & 16B, nozzle 30A, and turbine 18. Working fluid pressure lines 20, and storage fluid pressure lines 21 connect compressors 16A & 16B, air storage 21A, heat exchangers 20A & 21A, and nozzle 30A. The nozzle is De Laval shaped and has a valve that moves to throttle the rate of fluid expansion driving the turbine 18. The compressors 16A & 16B have directional control outlet valves, as well as intake control valves 31A and 31B. The heat sources include the following: recuperated waste heat 20A, regenerated heat of compression 21A, external heat absorber 14.

### CROSS-REFERENCE TO RELATED APPLICATIONS

This application claims the benefit of U.S. provisional patent application Ser. No. 61/126,805, filed May 5, 2008 by the present inventor.

### FEDERALLY SPONSORED RESEARCH

Not Applicable.

### SEQUENCE LISTING

Not Applicable.

### BACKGROUND

1. Field of the Invention

This invention pertains to the art and methods of heat engines, more particularly to those methods for energy conversion between mechanical work, compressed fluid, and heat flux.

2. Prior Art

Heat flux is thermal energy transfer associated with the motions of atoms and molecules that comprise matter. Heat flows between matter that is not in thermal equilibrium. Chemical reactions can decrease (endothermic) or increase (exothermic) heat content. Absorbing or emitting radiation (photon) increases or decreases heat content (phonon). Heat of compression relates temperature change to a pressure change, as well as the specific heat capacity. Friction and anything that increases vibrations of particles within matter generates heat. Heat sources are numerous. However, the low cost of heat from the combustion of fossilized carbon is at present the most common source used for heat engines.

A heat engine is a device that converts thermal (heat) flux into mechanical work. Common heat engines include gasoline (petrol), diesel, steam, and many others. A heat engine typically operates when heat flow (flux) is applied to one of the engines cycles. Part of this added heat is converted into mechanical work. In simple terms a compressible fluid takes up more volume after being heated, so expanding it can do more work than compressing required at its original temperature. Engines that idle do so because compression requires work, these engines hold a minimal amount of potential energy (ability to do work) as rotational inertia. A steam turbine driven by a nozzle valve with De Laval shape is used in some Rankine cycle heat engines. The latent heat of vaporization (boiling) needed to generate steam is less efficient than using the same heat to operate the most efficient thermodynamic cycles possible, in other words, Carnot, and by corollary to Carnot's theorem all reversible (Isothermal, Isentropic) heat engines.

Brayton's “Ready Motor” invention U.S. Pat. No. 125,166 was implemented with positive displacement pistons that operate on a working fluid in a constant-pressure (isobaric) process external from the compressor or expander. A positive displacement expander has a set volume that governs the mass flow (amount) of working fluid processed for a given speed and fluid pressure. The part of the stroke where working fluid is isolated and expanded within the expander is called dead volume. The dead volume as a ratio of intake volume should be proportional to the working fluid pressure as a ratio of the exhaust pressure to fully expand the compressed fluid. The application of the “Ideal gas law”, gives designers guidance with this relationship. Adjusting positive displacement dead volume expansion is a tricky process well beyond the actions of a simple throttle control. A positive displacement compressor has similar concerns. When Brayton cycle expanders and compressors operate together they form a configuration with compression and expansion mass flow relations that are mechanically set, which also govern the heat addition that can result in complete expansion, which is required for reversible operation. Moving away from reversible operating conditions reduces the work output as a function of heat input, the efficiency. It can be advantageous to add complexity to gain nearly complete expansion, which justifies the Atkinson cycle. The ideal Brayton cycle is a reversible heat engine with complete expansion and has a theoretical maximum efficiency like the Carnot cycle. Recuperative heat recovery can be added to the “Ready Motor” as U.S. Pat. No. 6,336,317 shows, while removing the heat of compression rather than adding to it yields the Bell Coleman cycle.

Brayton's invention used a thermodynamic cycle that has become the modern day jet or turbine engine, which has a high power density and is suitable for aviation and other base loads. The Brayton Cycle operates with constant-pressure (isobaric) and speed, responsiveness is poor when speed or load changes occur due to the difficulty in reestablishing near reversible cycle conditions. Base loads are not dynamic, for example, vehicles that accelerate (start) and slow (stop), and significant electrical energy usage has a dynamic load content and requires responsive power sources.

One way to deal with load changes is to use a flywheel, unfortunately that results in undesirable startup time. A Rankine cycle steam engine has high pressure steam ready to drive a piston or turbine during load changes, and it is noted that some Rankine cycle turbine configurations allow for moderate or even quick load changes. Steam needs held at temperature until used therefor storing it as a compressed working fluid is not recommended. When positive displacement expanders operate with complete reversible expansion from a stored compressed fluid, the work output is pressure and engine speed dependent (not responsive). Adjusting for efficient operation during load changes within a Brayton cycle engine is an intensive operation that establishes a constant or isobaric working fluid pressure. Insofar as I am aware, no heat engine formerly developed shows and desires an externally processed (working) fluid pressure that is free to change, thus independent of speed, heat input, and work output during engine operation.

### SUMMARY

In accordance with one embodiment a heat engine comprises compressed air storage, heat of compression regeneration, waste heat recuperation, air storage compressor, working fluid compressor, working fluid path which connects compressors, air storage, heat exchangers and a nozzle valve that throttles the mass flow of the compressed working fluid and then expands the compressed working fluid to drive a turbine.

### DRAWINGS—FIGURES

In the Drawings, closely related elements have the same number but different alphabetic suffixes.

FIG. 1 shows combustion as heat source.

FIG. 2 shows solar absorber as heat source.

FIG. 3 shows integration with a common engine as waste heat source.

### DRAWINGS—REFERENCE NUMERALS

11 Combustion
12 Common Engine
14 External Radiation Absorber
16A Working Fluid piston Compressor with directional flow reed valves
16B Storage piston Compressor with directional flow reed valves
18 Turbine
20 Working Fluid Path (Pressure Line)
20A Recuperative Heat Exchanger (recover waste heat)
21 Storage Fluid Path (Pressure Line)
21A Heat of Compression Regenerative Heat Exchanger
21D Storage Volume
22 Coupling Shaft
23 Combustion Chamber Cooling Heat Exchanger
24 Power Takeoff Connection
27A Heat of Compression Cooling Valve
27B Common Engine Combustion Chamber Cooling Valve
29 Storage Isolation Valve
30A De Laval Nozzle Valve (or an array of them)
31A Working Fluid Compressor Vacuum Control Valve
31B Storage Fluid Compressor Vacuum Control Valve
31C Otto cycle Manifold Vacuum Control Valve

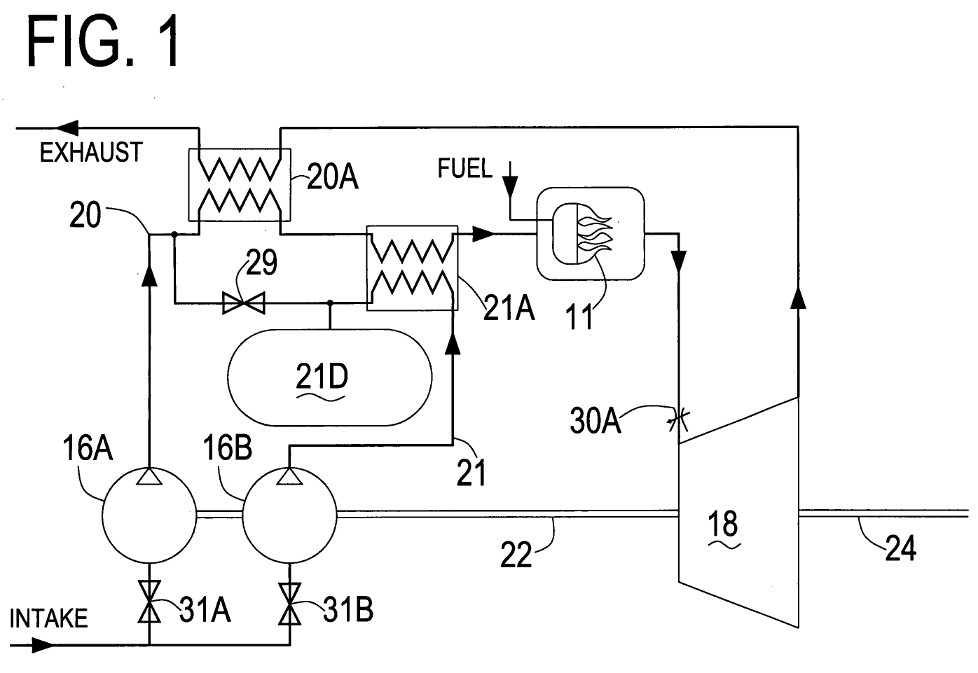

### DETAILED DESCRIPTION—FIG. 1—PREFERRED EMBODIMENT

One embodiment of the Engine is illustrated in FIG. 1. This embodiment is made up of the following elements a storage fluid path 21, compressed air storage 21D, air storage compressor 16B, storage isolation valve 29, and a quasi-isobaric thermodynamic cycle. The quasi-isobaric thermodynamic cycle further uses the following elements, a working fluid compressor 16A, a waste heat recuperative heat exchanger 20A, a heat of compression regenerative heat exchanger 21A, a combustion chamber 11, a nozzle valve 30A, a turbine 18, a work coupling shaft 22, a power takeoff shaft 24, a working fluid path 20, and air intake valve 31A and 31B.

### Operation—FIG. 1

These elements are connected and operate as follows; the positive displacement storage compressor 16B makes use of work from breaking or excess heat to compress air for storage 21D. The air storage 21D compressed air potential is available when needed by opening valve 29 or can be utilized as a pneumatic power source. Storage of compressed air makes heat available due to the heat of compression, which is heat exchanged 21A into the working fluid. The rest of the engine performs a thermodynamic cycle in which the working fluid potential is increased with compressor 16A, followed by adding heat flux (detailed bellow) along the working fluid path 20 that further increases the potential to do work, before the working fluid passes though a De Laval nozzle shaped valve 30A. The nozzle valve 30A throttles the compressed working fluid 20 and expands (converts the potential energy of) compressed air into a kinetic flow that produces an impulse force on the turbine 18; the impulse force is coupled onto a rotating shaft 22. Compressors 16A and 16B as well as the power takeoff 24 are coupled with the rotating shaft 22 that provides the mechanical power they use. Directional control valves in compressor(s) 16A and 16B block back flow from the working fluid 20 and storage fluid 21 onto the compressor(s) displacement surfaces. The engines primary control or throttle is to adjust the nozzle 30A. A simple example is to use a screw with a valve at its end to adjust the nozzle 30A restriction. Open the storage isolation valve 29 to pressurize working fluid and start engine. Coupling the power takeoff 24 with an induction machine tied to the grid will generate electrical power. Adjusting the nozzle valve 30A as a throttle control yields an extremely responsive feel with compressed fluid storage 21A and storage isolation valve 29 opened. Further optimizations include control of working fluid pressure 20, and storage pressure 21 within desired ranges. Recuperative heat recovery is more efficient when the working fluid pressure 20 is lower, thus yielding a guideline for controlling the intake valve 31A. The control of 31B has to do with adding stored compressed air 21D during regenerative load control (slowing down), engine utilization during low power takeoff, and heat salvaging. Compressed air can also be a power takeoff in which case the preference for controlling the engine is to actuate valve 31B that feeds compressor 16B as a function of desirable air pressure storage in 21D. With the remaining controls being typical for most applications, which are to actuate 30A as a throttle to control engine speed, and 31A to control pressure of working fluid.

Heating the working fluid along its path 20 is done in steps that proceed from lower to higher temperature. The figure starts with recuperative heat exchanger 20A that recovers waste heat from turbine 18 exhaust. Then a heat of compression regenerative heat exchanger 21A recovers the heat of compression that would otherwise be lost while in storage. Finally, heat from combustion in the combustion chamber 11 optionally followed by reaction catalyst to create peak temperatures along the working fluid path 20 just before expansion occurs at the De Laval nozzle 30A. If the temperature of the working fluid is above the waste heat source then heat exchange should be bypassed.

A pulsed operating mode is possible when storage 21D is a reasonably high pressure the engine storage isolation valve 29 can be opened intermittently to increase the working fluid pressure during which time high combustion temperatures can briefly develop on the high-pressure side of a high refractory De Laval nozzle valve 30A. The nozzle valve can be cycled to increase and decrease the restriction as a function of the working fluid pressure pulses, thus providing a way of reducing the effects of the pulses on power output. At high pressures the expanded fluid cools substantially allowing the turbine to be manufactured from normal materials like steel. After valve 29 is closed the working fluid pressure decrease which allows more effective heat recuperation to occur, and a much lower average operating temperature.

Additionally contemplated compressors 16A and 16B include but is not limited to bellows, scroll, gear pump (screw and geroter), and quasiturbine. It is believed that a directional valve is required for all these compressors and if a turbine compressor is devised with satisfactory directional valves it may also function. Additionally contemplated coupling shaft 22 options include but is not limited to crank shaft, gears, and pulley belts. While additionally contemplated turbine 18 include but is not limited a multi stage turbine. Furthermore, an additionally contemplated nozzle valve 30A configuration includes but is not limited to an array of nozzle valves.

To be sure, the use of a compressor and a nozzle driving a turbine has been tried in the past. See, for example, U.S. Pat No. 1,575,819, U.S. Pat Nos. 2,519,010, and 4,170,116, in which the working fluid was intended for refrigerating and was cooled to a liquid (condenser) before entering the nozzle. In the present configuration, the working fluid is heated (not condensed) before expansion which increases the volume and thus potential ability to do work. Of particular interest that I have not found previously recognized is how a throttling nozzle valve allows the working fluid pressure to vary independent of the engines speed, thus allowing the engine to both store or utilize compressed air with nearly reversible conditions throughout the engines usable speeds and heat input. I say nearly reversible in the sense of approaching the condition, truly reversible operation is impossible due to friction and heat loss.

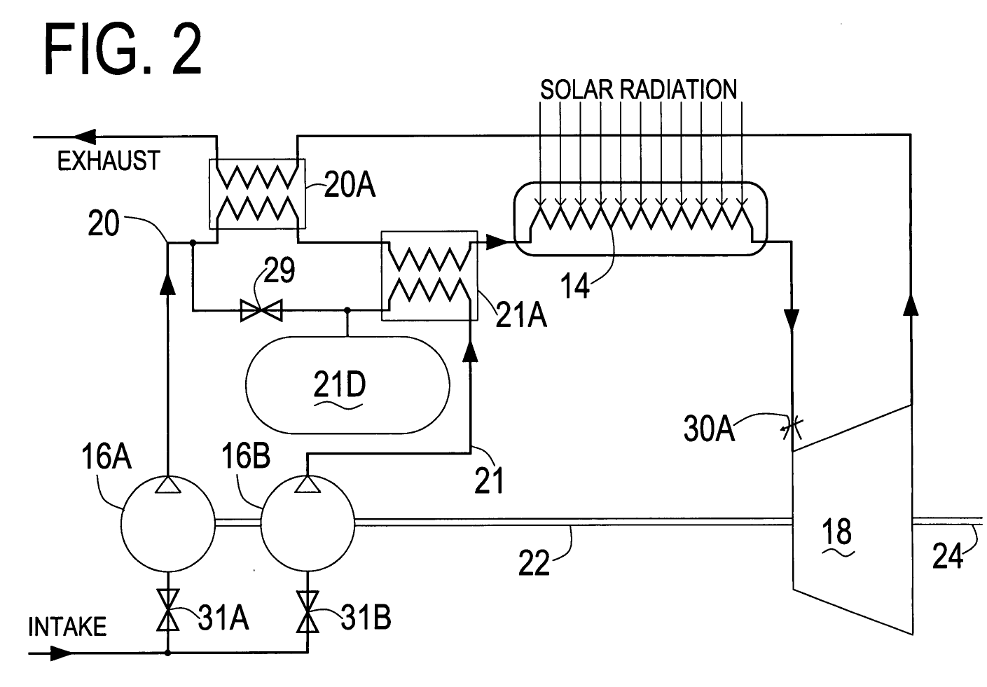

### Description—FIG. 2—Additional Embodiment (External)

An additional embodiment of the engine is shown in FIG. 2. This embodiment is the same as the previous except that the heat flux source is external, the combustion chamber 11 is removed and a radiant absorber vessel 14 is used.

### Operation—FIG. 2

The absorber vessel 14 transfers the heat into the working fluid and isolates the high emissivity surface from the working fluid 20. Emissivity is the ratio of energy radiated by the surface to the energy radiated by a black body, it is a measure of the ability to absorb and radiate energy. The absorber vessel may include heat storage capabilities. The rest of the engine functions the same, however, it should be noted that the compressed air storage can be expanded without heating (Bell Coleman Cycle) to yield an air cooling (conditioning) method, which is useful in locations with significant radiant energy (solar) and high temperatures.

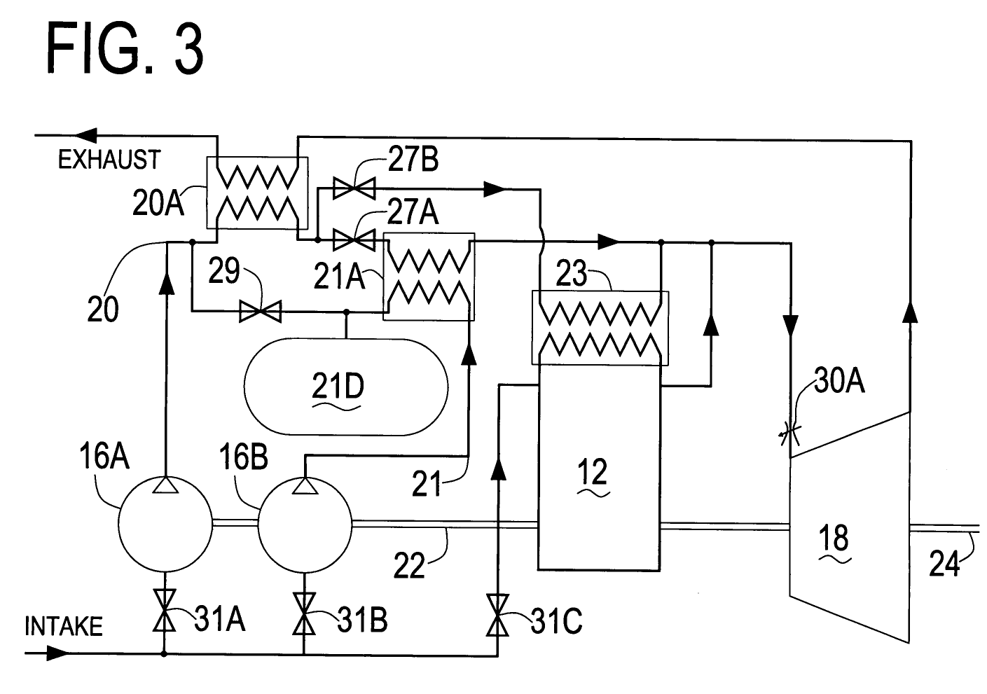

### Description—FIG. 3—Additional Embodiment (Salvaging)

An additional embodiment of the engine is shown in FIG. 3. This embodiment removes the combustion chamber 11 and radiant absorber 14 and couples a known Otto or Diesel (or ilk) Cycle engine 12. In addition a combustion chamber cooling heat exchanger 23, heat of compression cooling valve 27A, common engine combustion chamber cooling valve 27B, and Otto cycle manifold vacuum control valve 31C are added.

### Operation—FIG. 3

Heat is salvaged from the common engine 12 exhaust and combustion chamber cooling heat exchanger 23 within the working fluid 20. Actuation of heat of compression cooling valve 27A, and common engine combustion chamber cooling valve 27B depend on the amount of storage preformed and the amount of combustion preformed. However, other engine processes remain the same.

### Advantages

From the description above, a number of advantages of some embodiments of my heat engine become evident:
(a) Complete expansion occurs, and the work output from the turbine is independent of the working fluid or storage fluid pressure, thus by allowing a De Laval nozzle valve to control the expansion of the compressed fluid, an operational power band has been eliminated and a known nearly isentropic expansion method is utilized.
(b) The power content of the heat of compression is a large percent of the power needed to compress, by recovering the heat of compression, compressed air storage is a more efficient operation.
(c) Heat salvaging from well known engines reduces the need for costly high refractory components, that are required in other engines (for example, U.S. Pat. No. 6,336,317).
(d) As the working fluid path is external from compression or expansion heat sources can be internal or external. Some internal examples include combustion fusion, and catalyzed reactions, while some external examples include photon absorption, geothermal, fission, fusion, exothermic reaction, friction, and heat storage phase change material. The sources can be parallel or series to provide redundancy or backup. For example, a combustion chamber placed after a solar absorber may provide combustion heat when solar radiation is not available.
(e) Compressed air storage is used by opening valve 29, to bring the working fluid 20 to the compressed storage fluid potential 21, which eliminates idle requirement, increases work output, and allows utilization of heat storage.
(f) Manifold vacuum control valves 31A and 31B can be simple valves that create an averaged vacuum in an intake manifold, or timed valves that cut off the compressors directional valve at some desired percentage of the induction volume, thus yielding recoverable work, additionally allowing working fluid 20 to flow into valve 31B.
(g) A closed cycle version of this engine can be used to evacuate a vessel while storing its compressed contents and then recover the work that was done.
(h) The usefulness of an engine is more than just its efficiency in converting heat into work, but also its ability to provide that work as needed, and efficiently integrate with a potential energy storage reservoir, while continuing to allow the engine designer a wide range of heat source and size possibilities.

### Conclusion, Ramifications, and Scope

Accordingly, the reader will see that this quasi-isobaric heat engine with air storage in the various embodiments can be used to convert heat flux into mechanical work, convert mechanical work into compressed air, or convert compressed air into mechanical work. The engine gains overall efficiency because it completely expands working fluid, and recovers heat of compression, as well as recuperating waste heat. The working fluid pressure is independent of engine speed, heat input, and work output, which allows the engine to efficiently adapt stored compressed fluid to loads. Further the working fluid pressure can be reduced to optimize waste heat recuperation as well as regenerating the heat of compression during reduced work output demands. Furthermore, the heat engine has the additional advantages that
it allows inclusion of heat storage reservoir(s);
it operates from the waste heat of a process or energy source;
it allows embedding additional thermodynamic cycles;
it allows multiple series or parallel heat sources running pulsed or continuous;
it provides compressed air;
it allows additional heat exchanger(s);
it allows operation with or without compressed fluid storage;
it allows operation with or without waste heat recuperation.

It should further be noted that: along the working fluid path, and in direction of flow, each heat addition should be a higher temperature than previous heat addition to exchange heat into the working fluid. The engine can be made of various materials, such as but not limited to aluminum, steel, any other metal or metal alloy, or any other sufficiently resilient material, but steel is preferable; moving parts are connected with various means such as but not limited to sleeves, bearings, and bushings, preferably with lubrication. Engine Assembly's are constructed with various means, such as but not limited to screws, nuts and bolts, retaining pins, rings, seals, adhesives, or friction. Thus the scope of the embodiment should be determined by the appended claims and their legal equivalents, rather than by the examples given.

I claim:

1. A heat engine based on a thermodynamic cycle which can vary its external working fluid pressure independent of said engines speed, heat input, and work output comprising: non-condensing compressible working fluid within a flow path, component(s) preforming compression that confine said working fluid at the start of said path, device(s) preforming throttled expansion that confines said working fluid at the end of said path, heat source(s) which heat said working fluid along the said path, turbine that converts flow from said throttled expansion into mechanical work which is coupled with the said component(s) preforming compression.

2. The heat engine of claim 1 wherein said component(s) preforming compression is positive displacement compressor(s) with directional valve(s).

3. The heat engine of claim 2 wherein said device(s) preforming throttled expansion is De Laval shaped nozzle valve(s).

4. The heat engine of claim 3 wherein said nozzle valve(s) provide means for independent mass flow of the working fluid between the compressor and expander.

5. The heat engine of claim 4 wherein said independent mass flow is the processing means that allow a nearly reversible thermodynamic cycle with a range of working fluid pressures.

6. A heat engine utilizing regenerated heat of compression based on a thermodynamic cycle which can vary its external working fluid pressure independent of said engines speed, heat input, and work output comprising: non-condensing compressible working fluid within a flow path, component(s) preforming compression that confine said working fluid at the start of said path, device(s) preforming throttled expansion that confines said working fluid at the end of said path, regenerated heat of compression exchanger, heat source(s) which heat said working fluid along the said path, turbine that converts flow from said throttled expansion into mechanical work which is coupled with the said component(s) preforming compression.

7. The heat engine of claim 6 wherein said component(s) preforming compression is positive displacement compressor(s) with directional valve(s).

8. The heat engine of claim 7 wherein said regenerated heat of compression exchanger is a counter flow heat exchanger that transfers heat from stored compressed fluid into working fluid.

9. The heat engine of claim 8 wherein said device(s) preforming throttled expansion is De Laval shaped nozzle valve(s).

10. The heat engine of claim 9 wherein said nozzle valve(s) provide means for independent mass flow of the working fluid between the compressor and expander.

11. The heat engine of claim 10 wherein said independent mass flow is the processing means that allow a nearly reversible thermodynamic cycle with a range of working fluid pressures.

12. A heat engine utilizing regenerated heat of compression and recuperated waste heat based on a thermodynamic cycle which can vary its external working fluid pressure independent of said engines speed, heat input, and work output comprising: non-condensing compressible working fluid within a flow path, component(s) preforming compression that confine said working fluid at the start of said path, device(s) preforming throttled expansion that confines said working fluid at the end of said path, regenerated heat of compression exchanger, recuperated waste heat exchanger, heat source(s) which heat said working fluid along the said path, turbine that converts flow from said throttled expansion into mechanical work which is coupled with the said component(s) preforming compression.

13. The heat engine of claim 12 wherein said component(s) preforming compression is positive displacement compressor(s) with directional valve(s).

14. The heat engine of claim 13 wherein said recuperated waste heat exchanger is a counter flow heat exchanger that transfers heat from exhaust into said working fluid.

15. The heat engine of claim 14 wherein said regenerated heat of compression exchanger is a counter flow heat exchanger that transfers heat from stored compressed fluid into working fluid.

16. The heat engine of claim 15 wherein said device(s) preforming throttled expansion is De Laval shaped nozzle valve(s).

17. The heat engine of claim 16 wherein said nozzle valve(s) provide means for independent mass flow of the working fluid between the compressor and expander.

18. The heat engine of claim 17 wherein said independent mass flow is the processing means that allow a nearly reversible thermodynamic cycle with a range of working fluid pressures.
